(19) United States
(12) Patent Application Publication
(10) Pub. No.: US 2021/0373842 A1
(43) Pub. Date: Dec. 2, 2021

(54) PROGRAMMABLE MIXING ON A MULTI-INTERFACE TELECOMMUNICATION DEVICE

(71) Applicant: Plantronics, Inc., Santa Cruz, CA (US)

(72) Inventors: Ramesh Theivendran, Scotts Valley, CA (US); Jorge Alberto Ortega Camacho, Tijuana (MX); Shatrughna Singh, Mesa, AZ (US); Charles Goodman, Saratoga, CA (US)

(73) Assignee: Plantronics, Inc., Santa Cruz, CA (US)

(21) Appl. No.: 16/885,164

(22) Filed: May 27, 2020

(51) Int. Cl. G06F 3/16

(52) U.S. Cl. CPC G06F 3/165; G06F 3/162

(57) ABSTRACT

A multi-interface telecommunication device includes a multitude of communication interfaces including: a telephone network interface configured to interface with a telephone network, a personal computer interface configured to interface with a personal computing device, a user communication interface configured to interface with a two-way audio device of a user operating the multi-interface telecommunication device, and a programmable mixer configured to process a multitude of audio signals associated with the multitude of communication interfaces according to a mixing instruction received from the personal computing device.

### BACKGROUND

Telecommunications frequently involves multiple participants or endpoints. For example, a phone call between two, three or more participants may be conducted as a conference call. In such a call, audio signals may be exchanged bidirectionally between the participants. The participants may be simultaneously connected such that when one participant speaks, other participants hear the speaking participant. Further, the participants may individually mute their microphones and/or speakers. Additional features, beyond locally muting individual microphones and/or speakers may be desirable, but requirements may differ, depending on the application. For example, a call center employee, an office assistant, and a receptionist, while all handling phone calls, may benefit from different features. Accordingly, increased control over the exchange of the audio signals in a programmable manner may be desirable.

### SUMMARY

In general, in one aspect, one or more embodiments relate to a multi-interface telecommunication device including communication interfaces and a programmable mixer. The programmable mixer is configured to process, according to a mixing instruction received from a personal computing device, audio signals associated with the communication interfaces. The communication interfaces include a telephone network interface configured to interface with a telephone network, a personal computer interface, configured to interface with a personal computing device, and a user communication interface configured to interface with a two-way audio device of a user operating the multi-interface telecommunication device.

In general, in one aspect, one or more embodiments relate to a system that includes a multi-interface telecommunication device including communication interfaces and a programmable mixer. The programmable mixer is configured to process, according to a mixing instruction received from a personal computing device, audio signals associated with the communication interfaces. The system also includes a user interface configured to provide the mixing instruction.

In general, in one aspect, one or more embodiments relate to a method for operating a multi-interface telecommunication device. The method includes obtaining mixing instructions from a personal computing device, programming a programmable mixer according to the mixing instructions, and processing audio signals by the programmable mixer according to the mixing instructions. The audio signals are associated with communication interfaces. The communication interfaces include a telephone network interface configured to interface with a telephone network, a personal computer interface configured to interface with the personal computing device, and a user communication interface configured to interface with a two-way audio device of a user operating the multi-interface telecommunication device.

Other aspects of the invention will be apparent from the following description and the appended claims.

### BRIEF DESCRIPTION OF DRAWINGS

FIG. 1A shows a multi-interface telecommunication device, in accordance with one or more embodiments of the disclosure.

FIG. 1B shows a personal computing device, in accordance with one or more embodiments of the disclosure.

FIG. 2 shows a programmable mixer of the multi-interface telecommunication device, in accordance with one or more embodiments of the disclosure.

FIGS. 3A, 3B, and 3C show examples of mixer configurations, in accordance with one or more embodiments of the disclosure.

FIGS. 4, 5A, 5B, and 5C show flowcharts describing methods of a programmable mixing on a multi-interface telecommunication device, in accordance with one or more embodiments of the disclosure.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, although the description includes a discussion of various embodiments of the disclosure, the various disclosed embodiments may be combined in virtually any manner. All combinations are contemplated herein.

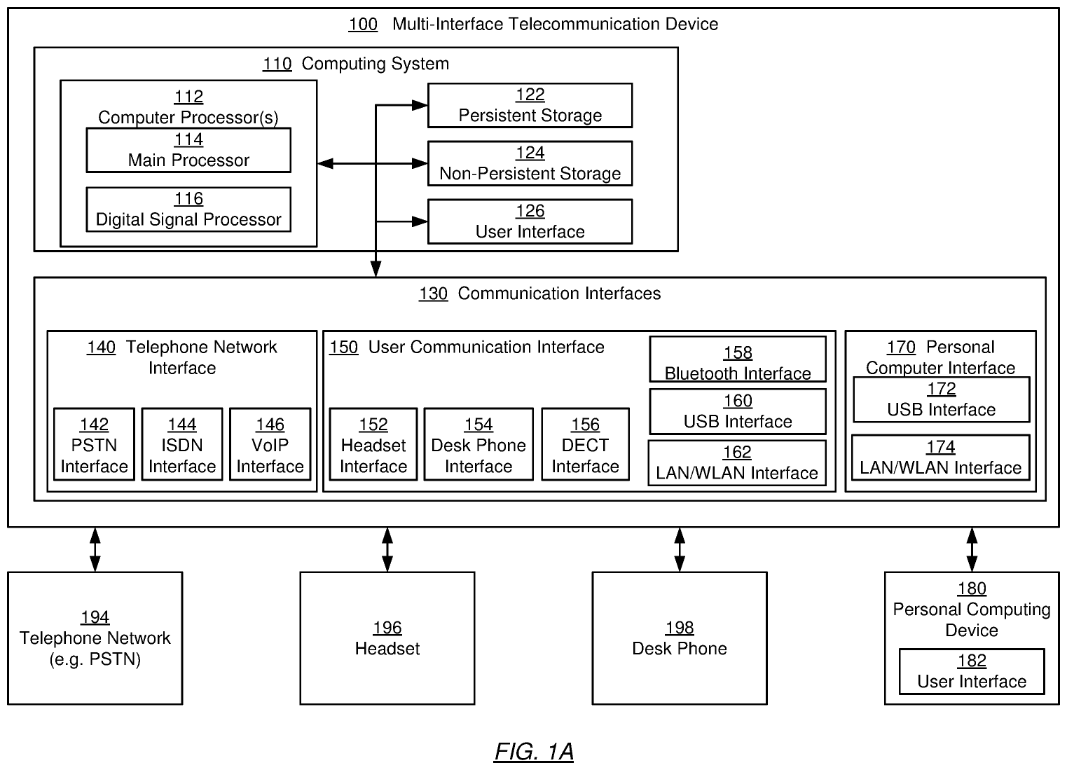

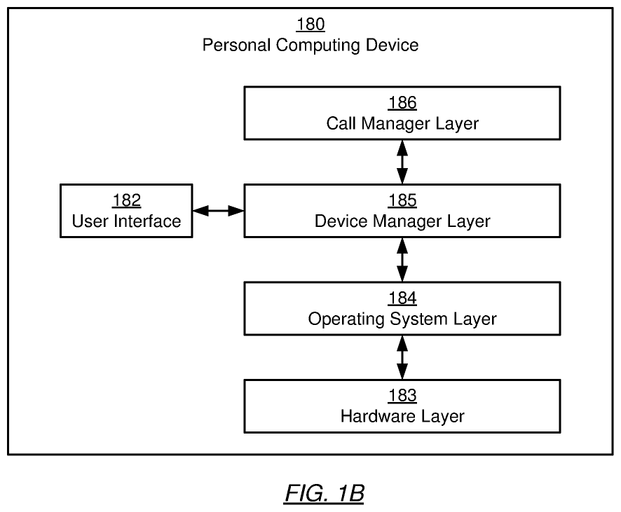

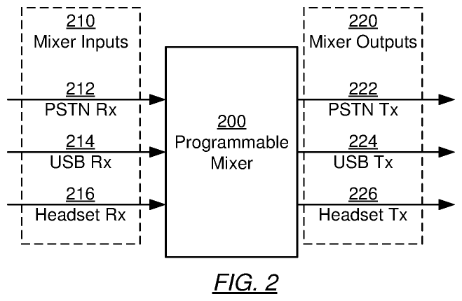

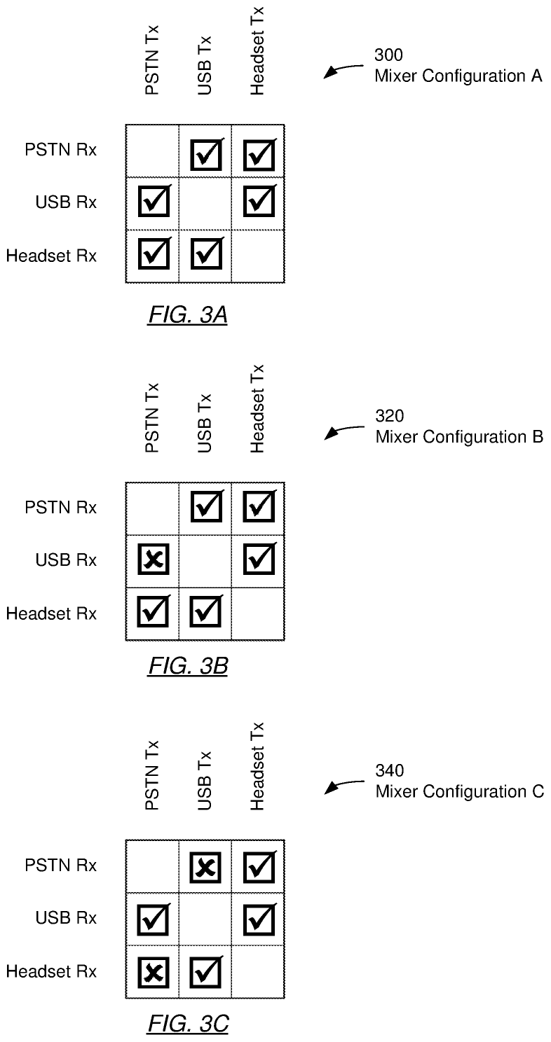

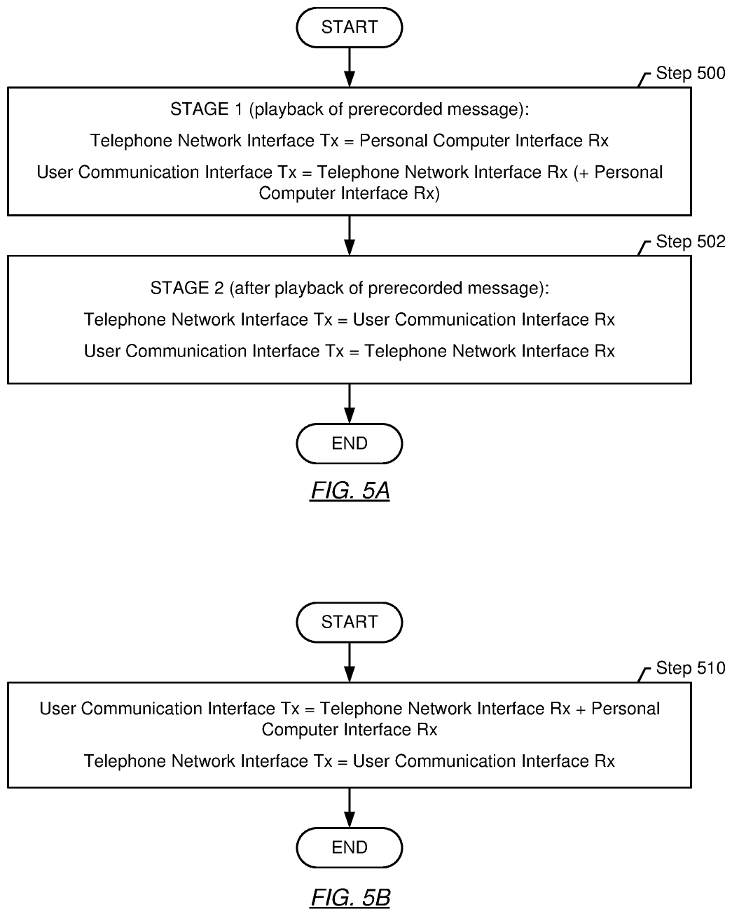

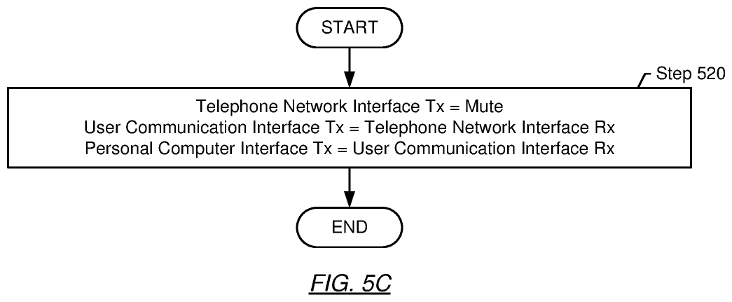

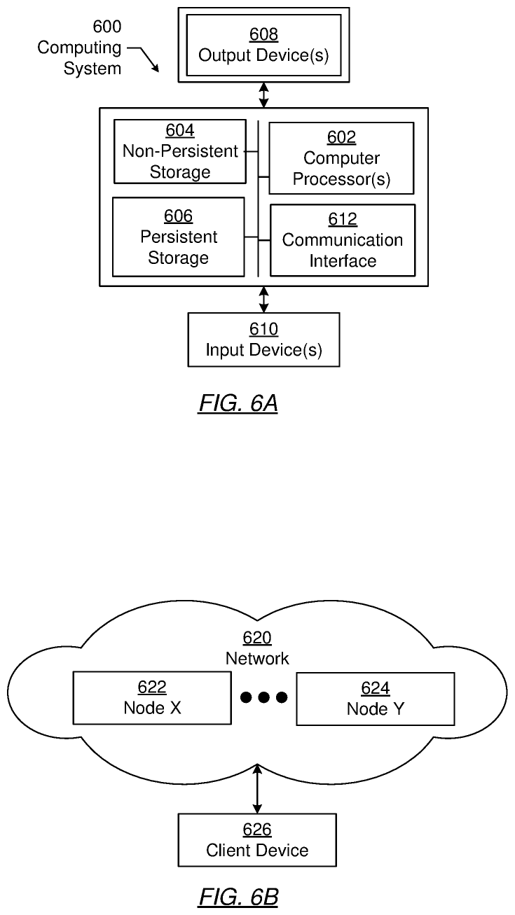

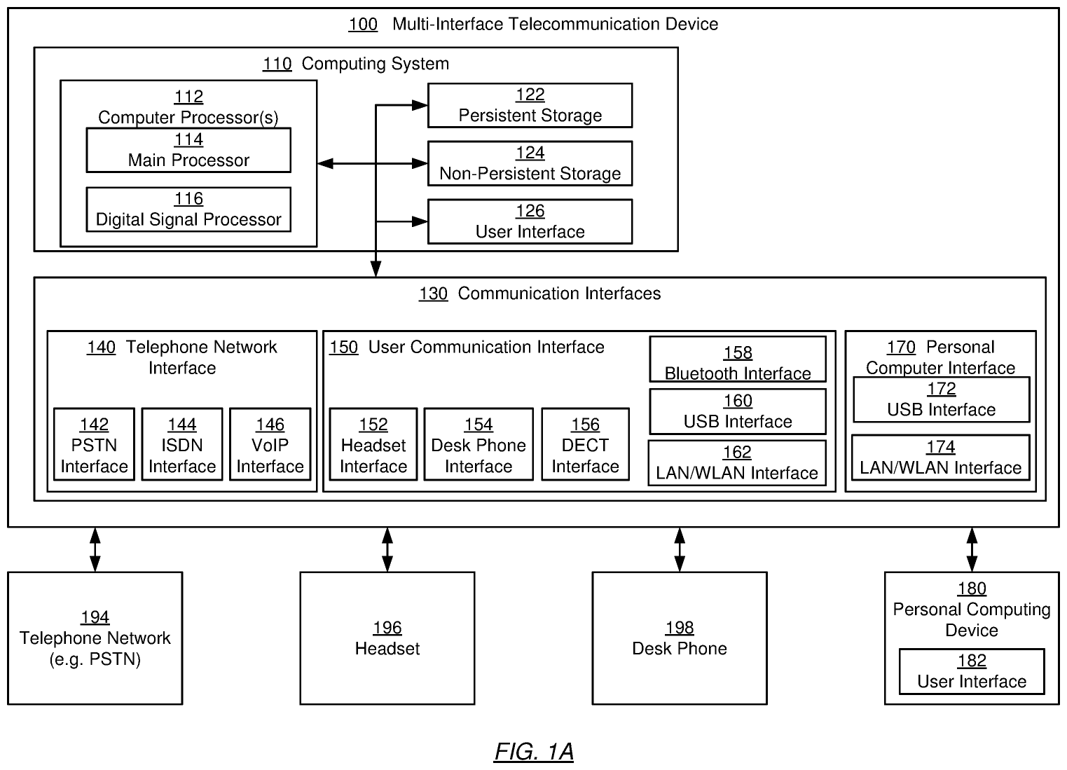

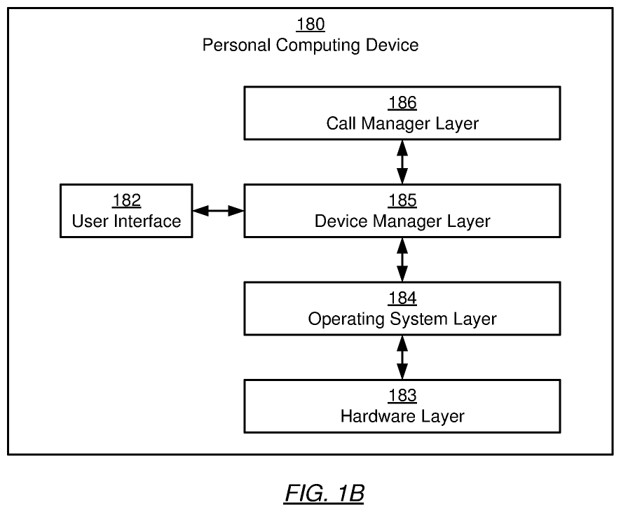

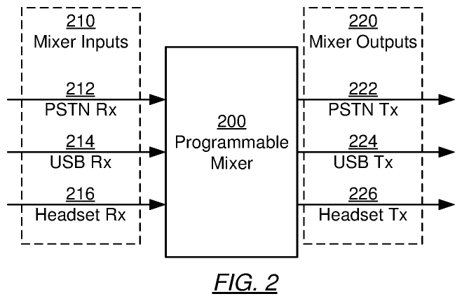

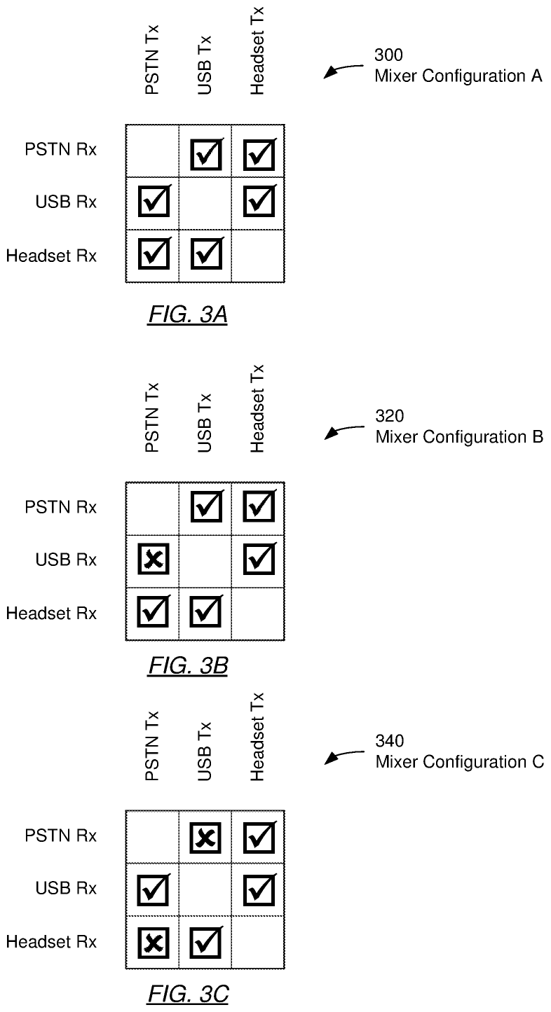

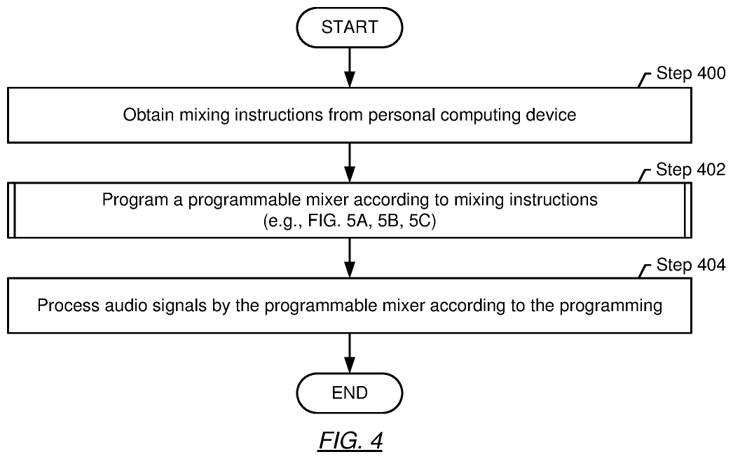

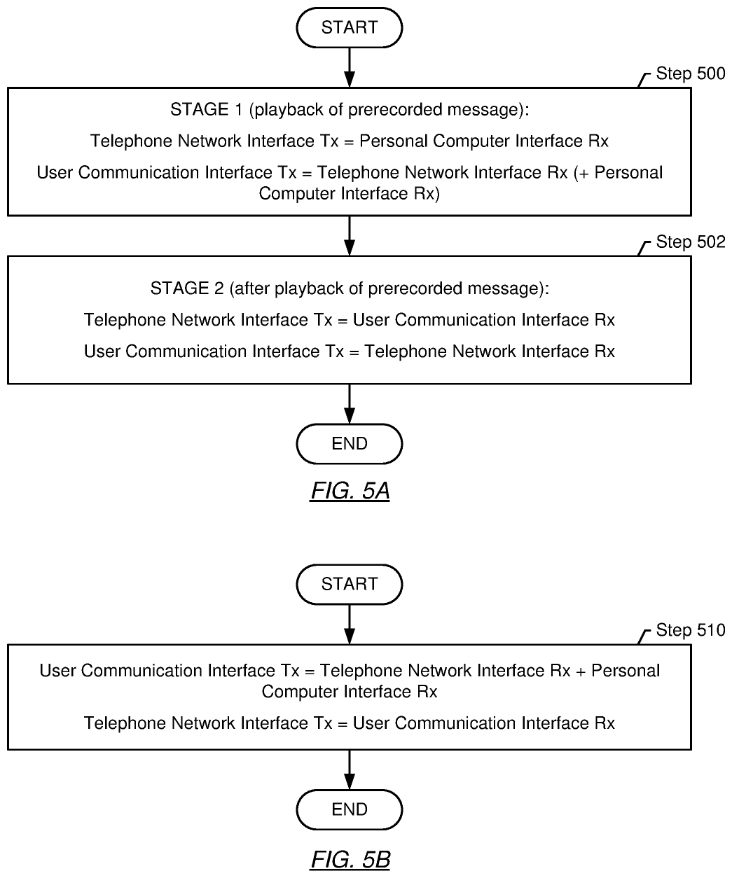

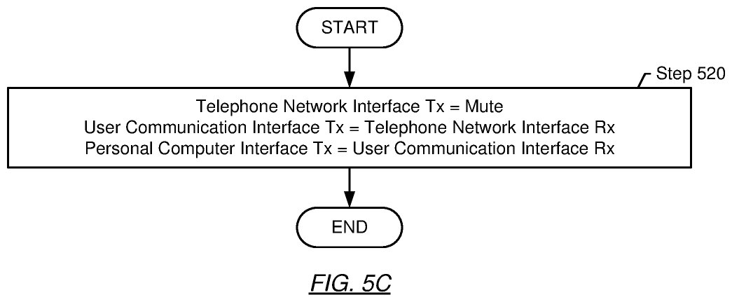

Embodiments of the disclosure enable a programmable mixing on a multi-interface telecommunication device. Telecommunication frequently involves multiple endpoints. For example, a telephone call may be conducted over a public switched telephone network (PSTN), interfacing a local endpoint, e.g., a cordless phone and a remote endpoint, e.g., a desk phone. In one or more embodiments, the local endpoint interfaces with the PSTN via a multi-interface telecommunication device, described below with reference to FIG. 1A. The multi-interface telecommunication device may support additional endpoints. For example, additional telephones and/or other audio transmitters and/or receivers, such as personal computing devices with audio recording/playback capabilities, may be connected. In one or more embodiments, the multi-interface telecommunication device includes a programmable mixer, allowing a programmable control of the transmission of audio signals between the endpoints interfacing with the multi-interface telecommunication device. The programmable mixer is discussed below, with reference to FIG. 2. In one or more embodiments, the programmable mixer supports various mixer configurations, including configurations that facilitate particular uses. Such applications are discussed below with reference to FIGS. 3A, 3B, 3C, 5A, 5B, and 5C.

Turning to FIG. 1A, a multi-interface telecommunication device (100) in accordance with one or more embodiments is shown. The multi-interface telecommunication device (100) is a standalone device, individual and distinct from other devices of the system. The multi-interface telecommunication device (100) includes a computing system (110), and multiple physical communication interfaces (130). Among other functions, the computing system (110) may implement a programmable mixer that selectively accepts incoming (RX, receive) audio signals from one or more of the multiple communication interfaces (130) for processing by the programmable mixer, and selectively outputs (TX, transmit) audio signals on one or more of the multiple communication interfaces (130) after the processing by the programmable mixer.

The computing system (110) may include various components, including one or more computer processors (112), persistent storage (122), non-persistent storage (124) and a user interface (126).

The one or more computer processors (112) may include one or more integrated circuits for processing instructions. For example, the computer processor(s) may be one or more cores or micro-cores of a processor. The one or more computer processors (112) may include a main processor (114) and/or a digital signal processor (DSP) (116). The main processor may (114) may execute an operating system and may be involved in communications with the personal computing device (180), described below with reference to FIG. 1B. The personal computing device (180) may be configured to receive commands from a user and/or a software application. The commands may, for example, specify a desired operation of the programmable mixer. The main processor (114) may then provide commands to the DSP (116) to parameterize the programmable mixer executing on the DSP. The DSP (116) may interface with the communication interfaces (130) and may receive audio signals obtained from the communication interfaces (130). The programmable mixer may process the audio signals, based on the parameterization received from the main processor. After the processing, the programmable mixer on the DSP (116) may provide the audio signals to the communication interfaces (130).

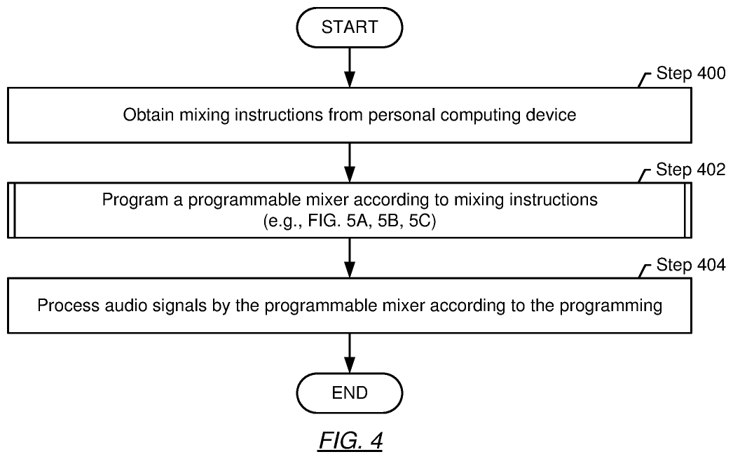

The persistent storage (122) may be a hard disk, an optical drive such as a compact disk (CD) drive or digital versatile disk (DVD) drive, a flash memory, etc., storing, for example, an operating system, and instructions, e.g., instructions implementing one or more of the steps described below with reference to FIGS. 4, 5A, 5B, and 5C.

The non-persistent storage (124) may be volatile memory, such as random access memory (RAM), cache memory, used when executing the steps described below.

The user interface (126) may include one or more buttons for locally controlling some of the functionality of the multi-interface telecommunication device (100). The user interface (126) may enable a user of the multi-interface telecommunication device (100) to accept incoming calls, merge calls, mute calls, switch between different mixer configurations, etc.

The communication interfaces (130), in one or more embodiments, include a telephone network interface (140), a user communication interface (150), and a personal computer interface (170). Each of these interfaces may be implemented using one or more interface technologies, as subsequently described.

In one or more embodiments, the telephone network interface (140) is an interface for the multi-interface telecommunication device (100) to a telephone network, e.g., the public telephone network. A public switched telephone network (PSTN) interface (142) may provide an analog interface for a single or multiple telephone lines, interfacing the multi-interface telecommunication device (100) with the public switched telephone network (PSTN) (194). A remote call participant may, thus, telephonically connect to a local call participant using the multi-interface telecommunication device (100). Additionally or alternatively, an integrated services digital network (ISDN) interface (144) may provide a digital interface to a public telephone network. In a voice over internet protocol (VoIP) implementation, the PSTN interface (132) may be substituted by a VoIP interface (146) operating over a local area network (LAN) or wireless local area network (WLAN) interface. Various bus systems may be used to interface the telephone network interface (140) with the computing system (110). Depending on the type of telephone network interface (140), additional components may be involved. For example, an analog-to-digital converter may convert an analog audio signal received via the PSTN interface (142) into a digital signal, and a digital-to-analog converter may be used to convert a digital signal to be transmitted into an analog signal suitable for transmission via the PSTN interface (142).

In one or more embodiments, the user communication interface (150) interfaces the multi-interface telecommunication device (100) with one or more user telecommunication devices. The user telecommunication devices are devices that include microphones and speakers for interfacing with a user. Example user telecommunication devices include a headset (196) and a desk phone (198). The user telecommunication devices may enable the local call participant to make use of the communication services provided by the multi-interface telecommunication device (100). The local call participant may also be the user controlling and operating multi-interface telecommunication device (100), as discussed below.

Different types of user communication interfaces (150) may be provided. A headset interface (152) may be an analog interface to a telecommunication headset (196) and may support single or dual-channel audio output (headset speaker(s)) and audio input (headset microphone). A desk phone interface (154) may be an analog or digital interface to a desk phone (198). A digital enhanced cordless telecommunications (DECT) interface may provide an interface to a cordless phone. A Bluetooth interface (158) may provide an interface to a Bluetooth headset or other Bluetooth communication device. A universal serial bus (USB) interface (160) may provide an interface to a USB headset or other USB communication device. A local area network (LAN) interface and/or wireless local area network (WLAN) interface may provide an interface to support a WiFi headset of other network-based communication device. Various bus systems may be used to interface the user communication interface (150) with the computing system (110). Depending on the type of user communication interface (140), additional components such as analog-to-digital and/or digital-to-analog converters may be involved. The multi-interface telecommunication device (100) may include more than one interface of one or more types of interfaces.

In one or more embodiments, the personal computer interface (170) interfaces the multi-interface telecommunication device (100) with one or more personal computing devices (180). A personal computing device (180) may be a desktop computer, a laptop computer, a tablet computer, etc. Different types of user personal computer interfaces (170) may be provided. For example, a USB interface (172) and/or a LAN or WLAN interface (174) may be provided.

The personal computing device (180) may include a user interface (182) configured to allow the user to control the operation of the multi-interface telecommunication device (100), as discussed in detail below. The personal computing device (180) may further be involved as a participant of a telecommunication, for example, by playing back audio stored on the personal computing device (180) and/or by recording audio during an ongoing telecommunication.

While FIG. 1A shows a configuration of components, other configurations may be used without departing from the scope of the disclosure. For example, the multi-interface telecommunication device (100) may include additional hardware and or software components, not shown in FIG. 1A. The multi-interface telecommunication device (100) may support any number of local and remote participants on any type of interface.

Turning to FIG. 1B, a personal computing device (180), in accordance with one or more embodiments, is shown. More specifically, FIG. 1B illustrates the interaction of various abstraction layers of the previously introduced personal computing device (180). A hardware layer (183) may include the hardware of the personal computing device (180) including a processor, volatile and non-volatile memory, communication interfaces such as a USB and/or network interface, user input interfaces such as keyboard and mouse, and/or user output interfaces such as a display, etc.

The operating system layer (184) may include operating system components such as the Win32 API and libraries and/or drivers for the hardware, e.g., a USB interface to provide access to the USB interface by the subsequently introduced software layers.

The device manager layer (185) may send/receive messages, e.g., in the human interface device (HID) 1.0 or 2.0 format, to/from the multi-interface telecommunication device (100). Messages from the multi-interface telecommunication device (100) may, for example, indicate incoming calls, button presses on the multi-interface telecommunication device (100), etc. Messages to the multi-interface telecommunication device (100) may include, for example, instructions for parameterizing the programmable mixer, e.g. when merging calls, etc.

The device manager layer (185) may further interface with the user interface (182). The input from the user interface may be used to generate the instructions sent to the multi-interface telecommunication device (100). The user interface (182) may provide individual buttons or other input elements to allow a user to configure the multi-interface telecommunication device (100) as desired. For example, the user interface may include separate buttons to parameterize the programmable mixer for dictating a message, or letting a remote caller listen to an announcement, to privately listen to a recording, etc., as described below. The device manager layer may further also receive messages indicating operation of the user interface (126) of the multi-interface telecommunication device (100), for example when a user presses a button to merge calls, to accept a call, etc.

In one or more embodiments, the device manager layer (185) also interfaces to audio sources and audio sinks of the personal computing device (180). Audio signals from/to the multi-interface telecommunication device (100) may be routed to/from the audio sources/sinks, as discussed below. An audio source may be an audio player, a streaming source, etc. An audio sink may be, for example, an audio recording application. The audio sources/sinks may be controllable via the device manage layer (185), e.g., to start/stop a playback or recording.

The call manager layer (186) may be where calls are managed, e.g., by accepting calls when detecting a button press operation for accepting the call, assigning an ID to the accepted call, merging the call with another call when detecting a button press operation for merging calls, etc. Other abstraction layers may exist, without departing from the disclosure. For example, an additional layer may provide plugins for third party software applications such a teleconference software applications.

Turning to FIG. 2, a programmable mixer of the multi-interface telecommunication device, in accordance with one or more embodiments of the disclosure, is shown. The programmable mixer (200) may be implemented in hardware using circuit elements and/or in software. In one or more embodiments, the programmable mixer (200) includes software instructions executing on the DSP (116) of FIG. 1A. The programmable mixer (200), in one or more embodiments has multiple mixer inputs (210) and multiple mixer outputs (210). Broadly speaking, the configuration of the mixer inputs (210) and mixer outputs (220) depends on the configuration of the communication interfaces (130) of FIG. 1A. A mixer input and a mixer output may exist for each of the communication interfaces (130).

In the example shown in FIG. 2, the programmable mixer interfaces with a telephone network interface (140) that is a PSTN interface. The programmable mixer further interfaces with a personal computer interface (170) that is a USB interface. In addition, the programmable mixer interfaces with a user communication interface (150) that is a headset interface. Accordingly, the mixer inputs (210) include a PSTN receive signal (212), a USB receive signal (214), and a headset receive signal (216). Similarly, the mixer outputs (220) include a PSTN transmit signal (222), a USB transmit signal (224), and a headset transmit signal (226). The PSTN receive signal (212) may be an audio signal received from a remote call participant, e.g., as the remote call participant speaks. The USB receive signal (214) may be an audio signal received from the personal computing device, e.g., an audio recording being played back. The headset receive signal (216) may be an audio signal received from the local call participant, e.g., as the local call participant speaks. The PSTN transmit signal (222) may be an audio signal transmitted to the remote call participant, e.g., as the local call participant speaks and/or as the audio recording is played back on the personal computing device. The USB transmit signal (224) may be an audio signal transmitted to the personal computing device, e.g., to record some of the audio of the ongoing telecommunication. The headset transmit signal (226) may be an audio signal transmitted to the local call participant, e.g., as the remote call participant speaks and/or as the audio recording is played back on the personal computing device. While FIG. 2 shows a programmable mixer with three mixer inputs and three mixer outputs of particular types, those skilled in the art will appreciate that a programmable mixer, in accordance with one or more embodiments, may have any number of mixer inputs and outputs of any type.

The programmable mixer (200), in one or more embodiments, is configured to process the audio signals received as mixer inputs (210), and to output the processed audio signals as mixer outputs (220). The processing may involve selectively passing one or more of the mixer inputs to one or more of the mixer outputs. A programming of the programmable mixer may determine what mixer input is passed to what mixer output. Thus, the programmable mixer is configured to selectively pass input signal from some input interfaces to some output interfaces while concurrently selectively blocking input signal to some output interfaces. In the following FIGS. 3A, 3B, and 3C, various examples of mixer configurations are shown. Subsequently, in FIGS. 4, 5A, 5B, and 5C, methods for programming the programmable mixer, and for processing the audio signals according to the programming, are shown. The processing of the audio signals may further involve other actions such as enhancing the audio signals, for example, by amplifying and/or filtering.

FIGS. 3A, 3B, and 3C show examples of mixer configurations, in accordance with one or more embodiments of the disclosure. In the examples, a mixer configuration is represented by a matrix. The matrix indicates the connection of mixer inputs (denoted Rx (receive), matrix rows) to mixer outputs (denoted Tx (transmit), matrix columns). The matrix is for a PSTN interface, a USB interface, and a headset interface. Generally, in the matrix, a checkmark symbol at the intersection of a row and a column indicates that the mixer output represented by the column is connected to the mixer input represented by the row. Conversely, in the matrix, an ‘X’ symbol at the intersection of a row and a column indicates that the mixer output represented by the column is disconnected from the mixer input represented by the row.

Turning to FIG. 3A, a mixer configuration A (300) is shown for a scenario in which the programmable mixer is programmed for 100% mixing. In a 100% mixing scenario all mixer inputs connect to all mixer outputs. However, an input of a particular interface does not connect to the output of the same interface. This scenario may be compared to a conference call, in which all participants are able to hear the other participants. For example, the PSTN Rx connects to USB Tx and to Headset Tx, but not to PSTN Tx. The configuration of the FIG. 3A causes the voice of a remote caller received via the PSTN Rx, to be transmitted to headset speakers of via the headset Tx. The configuration of FIG. 3A further causes, for example, the voice of the remote caller to be recorded using an audio recording application on the personal computing device, via the USB interface.

Turning to FIG. 3B, a mixer configuration B (320) is shown for a scenario in which the programmable mixer is programmed for a limited mixing. Specifically, the USB Rx is excluded from the PSTN Tx. The configuration of FIG. 3B causes, for example, an audio playback received from the personal computing device to be heard by the local participant via the headset, but not by the remote caller over the PSTN. The local participant may thus privately listen to the audio playback. At the same time, the local participant may hear the communication from a remote caller. Thus, the local participant may concurrently hear communication from the personal computing device and the remote caller, and concurrently speak with the remote caller, while concurrently excluding the remote caller from hearing communications from the personal computing device. Other aspects of the mixer configuration may be similar to the mixer configuration A (300) of FIG. 3A. The programming of the programmable mixer to obtain mixer configuration B, and possible applications are described below with reference to the flowcharts of FIGS. 4 and 5B.

Turning to FIG. 3C, a mixer configuration C (340) is shown for a scenario in which the programmable mixer is programmed for a limited mixing. Specifically, the PSTN Rx is excluded from the USB Tx. In addition, the Headset Rx is excluded from the PSTN Tx. The configuration of FIG. 3C would allow, for example, the local participant to dictate a message that is record by the personal computing device via the USB interface, while being connected to the remote caller via the PSTN interface. Other aspects of the mixer configuration may be similar to the mixer configuration A (300) of FIG. 3A. The programming of the programmable mixer to obtain mixer configuration C, and possible applications are described below with reference to the flowcharts of FIGS. 4 and 5C.

While FIGS. 3A, 3B, and 3C introduce particular mixer configurations, those skilled in the art will appreciate that the programmable mixer may support many other mixer configurations, without departing from the disclosure.

FIG. 4, and FIGS. 5A, 5B, and 5C show flowcharts in accordance with one or more embodiments. The flowcharts of FIG. 4, and FIGS. 5A, 5B, and 5C depict methods for a programmable mixing on a multi-interface telecommunication device. One or more of the steps in FIG. 4, and FIGS. 5A, 5B, and 5C may be performed by various components of the systems, previously described with reference to FIGS. 1A and 1B.

While the various steps in these flowcharts are presented and described sequentially, one of ordinary skill will appreciate that some or all of the steps may be executed in different orders, may be combined or omitted, and some or all of the steps may be executed in parallel. Additional steps may further be performed. Furthermore, the steps may be performed actively or passively. For example, some steps may be performed using polling or be interrupt driven in accordance with one or more embodiments of the invention. By way of an example, determination steps may not require a processor to process an instruction unless an interrupt is received to signify that condition exists in accordance with one or more embodiments of the invention. As another example, determination steps may be performed by performing a test, such as checking a data value to test whether the value is consistent with the tested condition in accordance with one or more embodiments of the invention. Accordingly, the scope of the disclosure should not be considered limited to the specific arrangement of steps shown in FIG. 4, and FIGS. 5A, 5B, and 5C.

Turning to the flowchart of FIG. 4, a method for a programmable mixing on a multi-interface telecommunication device, in accordance with one or more embodiments, is shown. Broadly speaking, the method programs a programmable mixer in a particular manner, and subsequently audio signals are processed by the programmable mixer according to the programming.

In Step 400, mixing instructions are obtained. In one or more embodiments the mixing instructions are obtained from a personal computing device. The personal computing device may include a user interface, accessible by a user of the multi-interface telecommunication device. The user interface may be an interface provided by the operating system of the personal computing device or a separate application. The user may simultaneously be a local call participant, e.g., in a telephone call between the local call participant and one or more remote call participants. The user interface includes user interface widgets for the user to specify the desired programming of the programmable mixer. For example, and referring to FIG. 2, the user interface may receive, via user interface widgets, user selections specifying a configuration for whether each of the mixer inputs (Rx) is providing (or not providing) an audio signal to each of the mixer outputs (Tx). Additionally or alternatively, the user interface receive a selection from the user as to a pre-defined mixer configuration, e.g., one of mixer configurations A, B, and C of FIGS. 3A, 3B, and 3C, to program the programmable mixer. The mixing instructions, received via the user interface of the personal computing device, may subsequently be provided to the multi-interface telecommunication device, e.g., using the human interfaces devices (HID) protocol via the personal computer interface of the multi-interface telecommunication device.

In Step 402, the programmable mixer is programmed according to the mixing instructions. Broadly speaking, the programming may involve parameterizing a mixing algorithm executing on a digital signal processor. Based on the programming, certain mixer inputs may or may not pass to certain mixer outputs. A more detailed description of the programming is provided below with reference to FIGS. 5A, 5B, and 5C.

In Step 404, the audio signals are processed by the programmable mixer, according to the programming. Accordingly, an audio signal received at a mixer input may or may not be forwarded, by the programmable mixer, to one or more of the mixer outputs.

Steps 400, 402, and 404 may be repeatedly executed to change the configuration of the programmable mixer, even throughout an ongoing telecommunication. Various use cases, described below, illustrate the programming and reprogramming of the programmable mixer, and the effect on ongoing telecommunications.

The following FIGS. 5A, 5B, and 5C show specific mixer programmings, in accordance with one or more embodiments. For the execution of the methods of FIGS. 5A, 5B, and 5C, assume that the multi-interface telecommunication device is equipped with a telephone network interface, a user communication interface, and a personal computer interface. The telephone network interface may be a PSTN interface allowing a remote call participant to join a telecommunication. The user communication interface may be a headset interface allowing a local call participant to join the telecommunication. The personal computer interface may be a user interface to a personal computing device, allowing the programming of the programmable mixer and other functionalities, discussed below.

Turning to FIG. 5A, a method for programming and reprogramming a programmable mixer to initially play back a prerecorded message to the remote call participant and to subsequently enable a telecommunication between the local and the remote call participant, is shown.

In Step 500, the programmable mixer is programmed to output, via the telephone network interface, a transmit signal (Tx) that includes a receive signal (Rx), received via the personal computer interface. The receive signal may include a prerecorded message and may originate from an audio player on the personal computing device. The programming of the programmable mixer may be coordinated with the playback of the prerecorded message. For example, Step 500 may be executed when accepting an incoming phone call on the telephone network interface. Upon execution of Step 500, and now referring to FIG. 4, Step 404, the prerecorded message, received via the personal computer interface, may be routed through the programmable mixer, and via the telephone network interface, to the remote call participant.

In addition, the programming may further involve programming the programmable mixer to output, via the user communication interface, a transmit signal (Tx) that includes a receive signal (Rx), received via the telephone network interface. During the execution of Step 404 of FIG. 4, the local call participant may, thus, be able to hear the remote call participant, although the remote call participant may not be able to hear the local call participant. In other words, the programmable mixer blocks the receive signal (Rx) from the user communication interface from the transmit signal (Tx) to the telephone network interface, by the programmable mixer.

The transmit signal (Tx) to the user communication interface may optionally include the receive signal (Rx) from the personal computer interface, allowing the local call participant to hear the prerecorded message.

In Step 502, the programmable mixer is reprogrammed to output, via the telephone network interface, a transmit signal (Tx) that includes a receive signal (Rx), received via the user communication interface. Accordingly, upon execution of Step 502, and now referring to FIG. 4, Step 404, the remote call participant may be able to hear the local call participant. The receive signal (Rx) from the personal computer interface may be excluded from the transmit signal (Tx). Accordingly, after the playback of the recorded message, the programmable mixer is reprogrammed to close the personal computer interface (Rx), and the signal from the personal computer interface is no longer routed to any interface.

The programmable mixer further continues to output, via the user communication interface, a transmit signal (Tx) that includes a receive signal (Rx), received via the telephone network interface, allowing the local call participant to hear the remote call participant.

The reprogramming of the programmable mixer may be coordinated with the completion of playing back the prerecorded message. For example, Step 502 may be executed shortly after the playback of the prerecorded message has ended.

Turning to FIG. 5B, a method for programming a programmable mixer to enable the local call participant to privately listen to an audio source on the personal computing device, is shown.

In Step 510, the programmable mixer is programmed to output, via the user communication interface, a transmit signal (Tx) that includes a receive signal (Rx), received via the personal computer interface. The receive signal may include a prerecorded message or any other audio signal and may originate from an audio player or any other audio source on the personal computing device. The programming of the programmable mixer may be coordinated with the playback of the prerecorded message. Upon execution of Step 510, and now referring to FIG. 4, Step 404, the audio signal, received via the personal computer interface, may be routed through the programmable mixer, and via the user communication interface, to the local call participant.

In addition, the programmable mixer may also pass a receive signal (Rx), received via the telephone network interface, to the user communication interface, allowing the local call participant to also hear the remote call participant, while listening to the audio signal from the personal computing device.

In addition, the programming may further involve programming the programmable mixer to output, via the telephone network interface, a transmit signal (Tx) that includes a receive signal (Rx), received via the user communication interface. During the execution of Step 404 of FIG. 4, the remote call participant may, thus, be able to hear the local call participant. The transmit signal (Tx) sent out via the telephone network interface, however, excludes the receive signal (Rx) from the personal computer interface to ensure that the audio signal from the personal computing device is available only to the local call participant. The programming discussed with reference to FIG. 5B may, at least partially, correspond to the mixer configuration B in FIG. 3B.

Turning to FIG. 5C, a method for programming a programmable mixer to enable the local call participant to privately record to an audio sink on the personal computing device, is shown.

In Step 520, the programmable mixer is programmed to mute the transmit signal (Tx) on the telephone network interface. Accordingly, no audio signal is provided to the remote call participant, and the remote call participant is therefore unable to hear the local call participant and/or other audio.

Further, the programmable mixer is programmed to output, via the user communication interface, a transmit signal (Tx) that includes a receive signal (Rx), received via the telephone network interface. Accordingly, the local call participant may be able to hear the remote call participant. Alternatively, the receive signal (Rx) received via the telephone network interface may not be included in the transmit signal (Tx) to the user communication interface.

In addition, the programmable mixer is programmed to output, via the personal computer interface, a transmit signal (Tx) that includes a receive signal (Rx), received from the user communication interface. Accordingly, the audio sink on the personal computing device may capture the audio signal originating from the local call participant, e.g., when the local call participant is dictating a message. The programming discussed with reference to FIG. 5C may, at least partially, correspond to the mixer configuration C in FIG. 3C.

The subsequently discussed use cases are to illustrate possible applications of a programmable mixing on a multi-interface telecommunication device. While only specific examples are described, those skilled in the art will recognize that the disclosure is not limited to these examples.

### Office Receptionist—Playback of a Welcome Message

Assume that a receptionist uses a multi-interface telecommunication device, in accordance with one or more embodiments, to answer customer calls. The receptionist wears a headset that is connected to a headset interface of the multi-interface telecommunication device. A desktop personal computer, also operated by the receptionist, is connected to a USB interface of the multi-interface telecommunication device. A PSTN interface connects the multi-interface telecommunication device to the public switched telephone network, allowing customers to call.

When the multi-interface telecommunication device receives a call via the PSTN interface, the multi-interface telecommunication device creates a PSTN call object for subsequent handling of the call. The call is initially in a ringing state.

Next, the receptionist presses a button on the user interface of the multi-interface telecommunication device to pick up the call. A button-press event is sent to the user interface on the personal computing device via a HID 2.0 protocol message over the USB interface.

Subsequently, the user interface on the personal computing device instructs the programmable mixer to pass the audio input (Rx) received via the USB interface of the multi-interface telecommunication device as a transmit signal (Tx) to the PSTN interface. Further, an audio player is instructed to play back the audio file comprising the desired greeting. The calling customer thus receives the greeting. The desired greeting to be played back may have been pre-selected prior to the incoming call, e.g., during a configuration or setup phase.

Once the greeting has been played back, the user interface on the personal computing device instructs the programmable mixer to stop passing the audio input (Rx) received via the USB interface of the multi-interface telecommunication device to the PSTN interface. Instead, the programmable mixer is programmed to pass audio input (Rx) received from the headset interface to the PSTN interface, thereby configuring the programmable mixer to allow the receptionist to talk to the customer.

Call Center—Privately Listening to Audio Information from Personal Computing Device

For this use case, assume a call center scenario with a customer support agent analogous to the receptionist. Further, assume that the telephone call between the customer support agent and the customer is already ongoing. During the call, the customer support agent realizes that, in order to address the customer's concern, she needs some background information. The background information is available as an audio recording stored on the personal computing device.

The customer support agent selects, in the user interface on the personal computing device, an option to reconfigure the programmable mixer of the multi-interface telecommunication device. More specifically, the option configures the programmable mixer to pass the audio input (Rx) received via the USB interface of the multi-interface telecommunication device as a transmit signal (Tx) to the headset interface, without passing the audio input (Rx) received via the USB interface as a transmit signal (Tx) to the PSTN interface. The programmable mixer may further be programmed to include the audio input (Rx) received via the PSTN interface in the transmit signal (Tx) to the headset interface. In this configuration, the customer support agent, while receiving background information, may still be able to hear the customer. The reconfiguration is sent to the multi-interface telecommunication device via a HID 2.0 protocol message over the USB interface.

Subsequently, an audio player is instructed to play back the audio recording comprising the background information. Alternatively, any other audio source, such as online audio sources, may be played back. The customer support agent thus receives the background information.

The customer support agent may reprogram the programmable mixer to exclude the audio input (Rx) received via the USB interface of the multi-interface telecommunication device as a transmit signal (Tx) to the headset interface, via the user interface, at any time.

### Office Assistant—Privately Dictating a Note

For this use case, assume a scenario in which an office assistant is handling a call with a customer. Further, assume that the telephone call between the office assistant and the customer is already ongoing. During the call, the office assistant wants to take some notes for later review by her supervisor. The office assistant would like to dictate these notes to the personal computing system which includes an audio recording application.

During the ongoing telephone call, the office assistant presses a button, either on the headset or on the multi-interface telecommunication device. A mute button-press event is sent to the user interface on the personal computing device via a HID 2.0 protocol message over the USB interface.

In the user interface on the personal computing device, the office assistant is allowed to control the configuration of the mute function. One setting allows a soft mute, in which the audio input (Rx) received via the headset interface of the multi-interface telecommunication device is forwarded as a transmit signal (Tx) to the personal computer interface. At the same time, the programmable mixer blocks the audio input (Rx) received via the headset interface of the multi-interface telecommunication device from the transmit signal (Tx) to the PSTN interface. The multi-interface telecommunication device is instructed to program the programmable mixer according to instructions send via a HID 2.0 protocol message over the USB interface.

The office assistant may now dictate her notes while the recording application on the personal computing device is recording. Unlike a conventional mute function which non-selective silences a microphone or a speaker, the described configuration provides a selective or soft mute, in which the muting is selectively applied. While the soft mute prevents the customer from hearing the office assistant, the office assistant may still dictate to the recording software application on the personal computing system.

Once the office assistant has completed dictating her notes, the soft mute operation may be terminated by another button press, causing a re-programming of the programmable mixer to the original state, which allows the office assistant and the customer to communicate.

The above use cases illustrate how the multi-interface telecommunication device can be programmed to accommodate various scenarios. The programmable mixer may be arbitrarily programmed as need or desired, and the programming may be performed via a user interface on a personal computing device in a straightforward manner. In the user interface, simple operations (such as a single clicks) may allow the user to pick an appropriate mixer programming. One icon may be for playing back a greeting, including programming the programmable mixer as described, another icon may be for dictating a message, including programming the programmable mixer as described, etc. Broadly speaking, the user interface may allow the user to request a particular action, thus causing the programming of the programmable mixer as needed. A single operation, such as the click of an icon may be sufficient to completely perform the action, including the programming, and/or activation of audio players/recorders, etc. The user interface may also allow the user to establish individual connections between mixer inputs and outputs and may allow the user to save newly generated mixer programmings. While the use cases describe particular programmings of particular interfaces, those skilled in the art will recognize that other programmings of any number and type of interfaces is supported, without departing from the disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A multi-interface telecommunication device comprising:
a plurality of communication interfaces comprising:
a telephone network interface, configured to interface with a telephone network,
a personal computer interface, configured to interface with a personal computing device, and
a user communication interface, configured to interface with a two-way audio device of a user operating the multi-interface telecommunication device; and
a programmable mixer configured to process a plurality of audio signals associated with the plurality of communication interfaces according to a mixing instruction received from the personal computing device.

2. The multi-interface telecommunication device of claim 1,
wherein the programmable mixer processing the plurality of audio signals, when accepting an incoming phone call on the telephone network interface, is programmed to output, via the telephone network interface, a transmit signal comprising a receive signal received via the personal computer interface.

3. The multi-interface telecommunication device of claim 2,
wherein the receive signal comprises a prerecorded message, stored on the personal computing device.

4. The multi-interface telecommunication device of claim 3,
wherein the programmable mixer, after a completed playback of the prerecorded message, is programmed to output, via the telephone network interface, the transmit signal comprising a receive signal received via the user communication interface.

5. The multi-interface telecommunication device of claim 1,
wherein the programmable mixer processing the plurality of audio signals, during a phone call using the telephone network interface, is programmed to:
output, via the user communication interface, a first transmit signal comprising a first receive signal received via the telephone network interface and a second receive signal received via the personal computer interface, and
output, via the telephone network interface, a second transmit signal comprising a third receive signal from the user communication interface and excluding the second receive signal.

6. The multi-interface telecommunication device of claim 1,
wherein the programmable mixer processing the plurality of audio signals, during a phone call using the telephone network interface, is programmed to:
block output on the telephone network interface, and
output, via the personal computer interface, a transmit signal comprising a receive signal received via the user communication interface.

7. The multi-interface telecommunication device of claim 1, wherein the mixing instruction is obtained from the personal computing device using a human interface devices (HID) protocol.

8. The multi-interface telecommunication device of claim 1,
wherein the programmable mixer comprises software instructions executed by a digital signal processor (DSP).

9. The multi-interface telecommunication device of claim 1,
wherein the telephone network interface comprises a public switched telephone network interface.

10. The multi-interface telecommunication device of claim 1,
wherein the personal computer interface comprises at least one selected from a group consisting of:
a universal serial bus (USB) interface,
a local area network (LAN) interface, and
a wireless local area network (WLAN) interface.

11. The multi-interface telecommunication device of claim 1,
wherein the user communication interface comprises at least one selected from a group consisting of:
a headset interface,
a Bluetooth interface,
a desk phone interface, and
a digital enhanced cordless telecommunications (DECT) interface.

12. A system comprising:
a multi-interface telecommunication device comprising:
a plurality of communication interfaces; and
a programmable mixer configured to process, according to a mixing instruction received from a personal computing device, a plurality of audio signals associated with the plurality of communication interfaces; and
a user interface executing on the personal computing device and configured to provide the mixing instruction.

13. The system of claim 12, wherein the user interface enables a selection between a plurality of mixer configurations for programming the programmable mixer with the mixing instruction, by a single operation by a user of the system.

14. The system of claim 12, further comprising:
an interface to at least one selected from a group consisting of an audio source and an audio sink on the personal computing device, controlled based on a programming of the programmable mixer.

15. A method for operating a multi-interface telecommunication device, the method comprising:
obtaining mixing instructions from a personal computing device;
programming a programmable mixer according to the mixing instructions; and
processing a plurality of audio signals by the programmable mixer according to the mixing instructions,
wherein the plurality of audio signals is associated with a plurality of communication interfaces, the plurality of communication interfaces comprising:
a telephone network interface, configured to interface with a telephone network,
a personal computer interface, configured to interface with the personal computing device, and
a user communication interface, configured to interface with a two-way audio device of a user operating the multi-interface telecommunication device.

16. The method of claim 15, wherein the processing of the plurality of audio signals by the programmable mixer according to the mixing instructions comprises:
when accepting an incoming phone call on the telephone network interface, outputting, via the telephone network interface, a transmit signal comprising a receive signal received via the personal computer interface.

17. The method of claim 16,
wherein the receive signal comprises a prerecorded message, stored on the personal computing device.

18. The method of claim 17, wherein the processing of the plurality of audio signals by the programmable mixer according to the mixing instructions further comprises:
after a completed playback of the prerecorded message, outputting, via the telephone network interface, the transmit signal comprising a receive signal received via the user communication interface.

19. The method of claim 15, wherein the processing of the plurality of audio signals by the programmable mixer according to the mixing instructions comprises, during a phone call using the telephone network interface:
outputting, via the user communication interface, a first transmit signal comprising a first receive signal received via the telephone network interface and a second receive signal received via the personal computer interface; and
outputting, via the telephone network interface, a second transmit signal comprising a third receive signal from the user communication interface and excluding the second receive signal.

20. The method of claim 15, wherein the processing of the plurality of audio signals by the programmable mixer according to the mixing instructions comprises, during a phone call using the telephone network interface:
blocking output on the telephone network interface, and
outputting, via the personal computer interface, a transmit signal comprising a receive signal received via the user communication interface.
